(19) United States
(12) Patent Application Publication
(10) Pub. No.: US 2008/0165381 A1
(43) Pub. Date: Jul. 10, 2008

(54) Methods and Systems for Controlling an Imaging Device

(76) Inventor: Andrew Rodney Ferlitsch, Camas, WA (US)

Correspondence Address: KRIEGER INTELLECTUAL PROPERTY, INC., P.O. BOX 1073, CAMAS, WA, 98607, US

(21) Appl. No.: 11/620,434

(22) Filed: Jan. 5, 2007

(51) Int. Cl. G06F 3/12

(52) U.S. Cl. 358/1.15

(57) ABSTRACT

Embodiments of the present invention comprise systems and methods for controlling an imaging device where the controlling application may be obtained by the imaging device from a storage system and provided to a hosted computing environment.

### FIELD OF THE INVENTION

Embodiments of the present invention comprise methods and systems for controlling an imaging device.

### BACKGROUND

The operation of an imaging device may be enhanced by a functionality provided by a remote application that may control the imaging device. The operation of an imaging device may be further enhanced by the capability of the imaging device to acquire controlling applications and install them on a hosted computing environment, which may in turn control the imaging device.

### SUMMARY

Some embodiments of the present invention comprise methods and systems for controlling an imaging device with a controlling application where the controlling application may be obtained from a storage system and provided to a hosted computing environment by the imaging device.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a drawing showing exemplary embodiments of the present invention comprising an imaging device, a remote computing device and a remote server;

FIG. 2 is a flow diagram showing embodiments of the present invention comprising an imaging device that may detect a controlling application on a removable storage media;

FIG. 3 is a flow diagram showing embodiments of the present invention comprising an imaging device that may extract a controlling application from a removable storage media on which the controlling application wholly resides and that may load the controlling application into a hosted computing environment;

FIG. 4 is a flow diagram showing embodiments of the present invention comprising an imaging device that may instruct a hosted computing environment to extract a controlling application from a removable storage media on which the controlling application wholly resides;

FIG. 5 is a flow diagram showing embodiments of the present invention comprising an imaging device that may extract a controlling application from a reference location at which the controlling application resides and that may load the controlling application into a hosted computing environment;

FIG. 6 is a flow diagram showing embodiments of the present invention comprising an imaging device that may instruct a hosted computing environment to extract a controlling application from a reference location at which the controlling application resides;

FIG. 7 is a flow diagram showing embodiments of the present invention comprising an imaging device that may extract a selected controlling application from a removable storage media on which the selected controlling application wholly resides and that may load the selected controlling application into a hosted computing environment;

FIG. 8 is a flow diagram showing embodiments of the present invention comprising an imaging device that may extract a selected controlling application from a reference location at which the selected controlling application resides and that may load the selected controlling application into a hosted computing environment;

FIG. 9 a flow diagram showing embodiments of the present invention comprising an imaging device that may detect a controlling application on an external storage system;

FIG. 10 is a flow diagram showing embodiments of the present invention comprising an imaging device that may extract a controlling application from an external storage system on which the controlling application wholly resides and that may load the controlling application into a hosted computing environment;

FIG. 11 is a flow diagram showing embodiments of the present invention comprising an imaging device that may instruct a hosted computing environment to extract a controlling application from an external storage system on which the controlling application wholly resides;

FIG. 12 is a flow diagram showing embodiments of the present invention comprising an imaging device that may extract a controlling application from a reference location at which the controlling application resides and that may load the controlling application into a hosted computing environment;

FIG. 13 is a flow diagram showing embodiments of the present invention comprising an imaging device that may instruct a hosted computing environment to extract a controlling application from a reference location at which the controlling application resides;

FIG. 14 is a flow diagram showing embodiments of the present invention comprising an imaging device that may extract a selected controlling application from an external storage system on which the selected controlling application wholly resides and that may load the selected controlling application into a hosted computing environment; and

FIG. 15 is a flow diagram showing embodiments of the present invention comprising an imaging device that may extract a selected controlling application from a reference location at which the selected controlling application resides and that may load the selected controlling application into a hosted computing environment.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

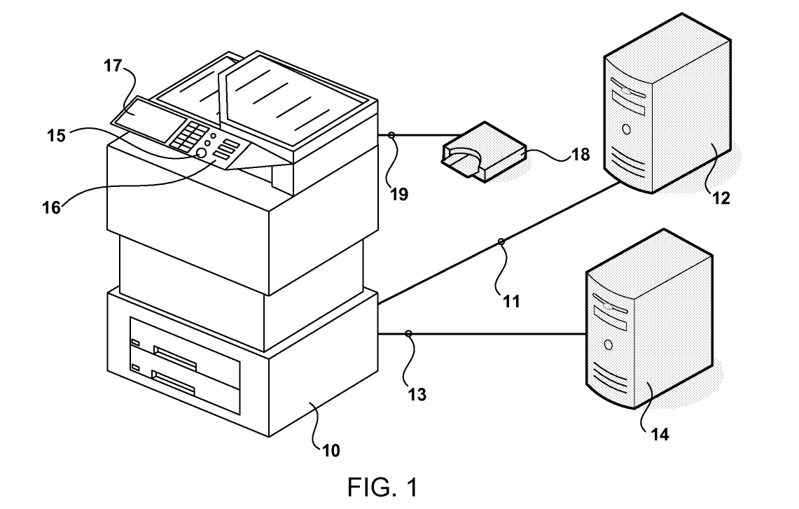

Exemplary embodiments of the present invention may be described in relation to FIG. 1. These exemplary embodiments may comprise an imaging device 10. In some embodiments, the imaging device 10 may take the form of a multi-function peripheral device (MFP) that combines the functions of two or more traditionally separated imaging devices. An MFP may combine any number of imaging devices, but typically comprises the functions of one or more of the following: a printer, a scanner, a copier, a filing device, a document management device and a fax machine. In alternate embodiments, the imaging device 10 may take the form of a single-function imaging device. Exemplary single-function imaging devices comprise a printer, a scanner, a copier, a filing device, a document management device and a fax machine.

The imaging device 10 may be connected to a remote computing device 12 and/or a remote server 14. In some embodiments, the remote computing device 12 and the remote server 14 may be distinct. In alternate embodiments, the remote computing device 12 and the remote server 14 may be the same device.

The connection 11 between the imaging device 10 and the remote computing device 12 may be any communications link, such as a network connection, a telephone line, a serial cable or some other wired or wireless communications link. Communication and transport of data between the imaging device 10 and the remote computing device 12 may be by any protocol or combination of protocols, of which exemplary protocols may comprise WS/SOAP (Web Services/Simple Object Access Protocol), SOAP/XML (Simple Object Access Protocol/eXtensible Markup Language), DIME (Direct Internet Message Encapsulation), FTP (File Transfer Protocol), NFS (Network File System), SMTP (Simple Mail Transfer Protocol), HTTP/HTML (HyperText Transfer Protocol/HyperText Markup Language), Email, a protocol over TCP/IP (Transmission Control Protocol/Internet Protocol) and AppleTalk®.

The connection 13 between the imaging device 10 and the remote server 14 may be any communications link, such as a network connection, a telephone line, a serial cable or some other wired or wireless communications link. Communication and transport of data between the imaging device 10 and the remote server 14 may be by any protocol or combination of protocols, of which exemplary protocols may comprise WS/SOAP, SOAP/XML, DIME, FTP, NFS, SMTP, HTTP/HTML, Email, a protocol over TCP/IP and AppleTalk®.

The imaging device 10 may further comprise a user interface (UI) panel 16, which may comprise input buttons 15 and a display device 17. In some embodiments, the display device 17 may comprise a touch panel system with or without input buttons 15.

The imaging device 10 may be communicatively coupled 19 with removable or external storage 18 via a hostless or hosted connection. Exemplary removable or external storage systems may comprise a USB (Universal Serial Bus) thumb drive, a memory stick reader, a CD-ROM/DVD (Compact Disk-Read Only Memory/Digital Versatile Disc) drive, a floppy disk drive, a cellular telephone, a PDA (Personal Digital Assistant), an FTP site, an HTTP site and network (or otherwise remote) mounted file system or storage. The connection 19 between the imaging device 10 and the removable or external storage 18 may be any communications link, such as a network connection, a telephone line, a serial cable or some other wired or wireless communications link. Communication and transport of data between the imaging device 10 and the removable or external storage 18 may be by any protocol or combination of protocols, of which exemplary protocols may comprise WS/SOAP, SOAP/XML, DIME, FTP, NFS, SMTP, HTTP/HTML, a protocol over TCP/IP and AppleTalk®. In some embodiments, the imaging device 10 may comprise an integral coupling mechanism for accessing removable or external storage. Exemplary integral coupling mechanisms may comprise a USB port, a parallel port, a serial port, a memory stick reader, a CD/DVD drive and a floppy disk drive.

In some embodiments, the display device 17 may be under the control of an external application, which may be hosted on the remote computing device 12, the remote server 14 or another computing host (not shown). In some embodiments, the external application may control the display device 17 via web services.

The imaging device 10 may also be under the control of an external application, which may be hosted on the remote computing device 12, the remote server 14, or another computing host (not shown). In some embodiments, the external application may control the imaging device 10 via web services.

One exemplary external application may be a remote application that may be used to perform a scan-to-server operation in which the remote application may control both the UI on the imaging device 10 and the scan operations. In this exemplary situation, the scanned data may be processed by a remote server 14, and the post-processed data may be passed to client destinations by either the remote server 14 or by the imaging device 10.

Another exemplary external application may be a remote application that may be used to control a walk-up print operation in which the remote application may control both the UI on the imaging device 10 and the print operations. In this exemplary situation, the remote application may be used to perform a print-from-removable-storage operation. The file data from the removable storage may be converted to printer ready data by a remote server 14, and the printer ready data may be sent back to the imaging device 10 for printing.

Embodiments of the present invention comprise methods and systems for controlling an imaging device with a controlling application that may be remote to the imaging device. Some embodiments of the present invention may use a controlling application that may not have been previously installed on a remote server or remote computing device. Some embodiments of the present invention may use a controlling application that may not have been previously registered by the imaging device or may not have been previously discovered by the imaging device. In some embodiments, the controlling application may control the UI for the imaging device front panel, may interpret responses input through the imaging device UI, may control imaging device functions (e.g., scan and print operations), may control pre-processing operations or may control post-processing operations. An exemplary pre-processing operation may be converting file data into printer-ready data. An exemplary post-processing operation may be OCR (Optical Character Recognition) of scanned image data.

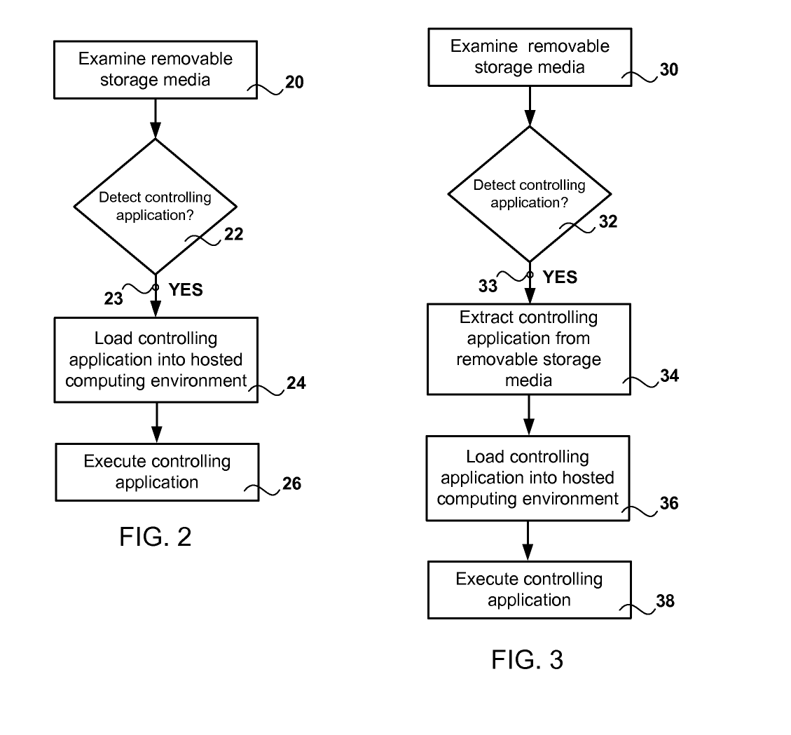

Some embodiments of the present invention may be described in relation to FIG. 2. An imaging device may initiate an examination 20 of a removable storage media. The imaging device may initiate the examination 20 when the removable storage media is communicatively coupled with the imaging device, when manually initiated by a user, when interactively initiated by a user upon prompting by the imaging device or when instructed to do so by a remote computing device. The examination may be initiated 20 to detect 22 whether or not a controlling application resides on the removable storage media. Exemplary methods by which the imaging device may detect 22 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects the presence of a potential controlling application, the imaging device may continue to read additional bytes until the presence or absence of a controlling application may be verified.

If the imaging device detects 23 a controlling application on the removable storage media, then the imaging device may load 24 the controlling application into a hosted computing environment which may control the imaging device. Exemplary hosted computing environments may comprise an external or remote server, an external or remote computing device and a guest operating environment within the imaging device. Exemplary methods by which the imaging device may load 24 the controlling application into a predefined location on the hosted computing environment may comprise FTP, NFS, HTTP, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make a remote procedure call (RPC) to the hosted computing environment to initiate a process on the hosted computing environment that may initiate the load application process.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 26. In some embodiments, execution 26 of the controlling application may be initiated manually by a user at the imaging device or elsewhere. In alternative embodiments, execution 26 of the controlling application may be initiated automatically by the hosted computing environment. In some embodiments, a hosted computing environment may run a monitoring process which may, continuously, periodically or on a defined schedule, monitor a predefined location for newly loaded controlling applications.

Some embodiments of the present invention may be described in relation to FIG. 3. An imaging device may initiate an examination 30 of a removable storage media. The imaging device may initiate the examination 30 when the removable storage media is communicatively coupled with the imaging device, when manually initiated by a user, when interactively initiated by a user upon prompting by the imaging device or when instructed to do so by a remote computing device. The examination may be initiated 30 to detect 32 whether or not a controlling application resides on the removable storage media. Exemplary methods by which the imaging device may detect 32 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects the presence of a potential controlling application, the imaging device may continue to read additional bytes until the presence or absence of a controlling application may be verified.

39 If the imaging device detects 33 a controlling application on the removable storage media, then the imaging device may extract 34 the controlling application from the storage media if the controlling application is wholly present on the storage media. The imaging device may then load 36 the controlling application into a hosted computing environment that may control the imaging device. Exemplary hosted computing environments may comprise an external or remote server, an external computing device and a guest operating environment within the imaging device. Exemplary methods by which the imaging device may load 36 the controlling application into a predefined location on the hosted computing environment may comprise FTP, NFS, HTTP, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make an RPC call to the hosted computing environment to initiate a process on the hosted computing environment which may initiate the load application process.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 38. In some embodiments, execution 38 of the controlling application may be initiated manually by a user at the imaging device or elsewhere. In alternative embodiments, execution 38 of the controlling application may be initiated automatically by the hosted computing environment. In some embodiments, a hosted computing environment may run a monitoring process which may, continuously, periodically or on a defined schedule, monitor a predefined location for newly loaded controlling applications.

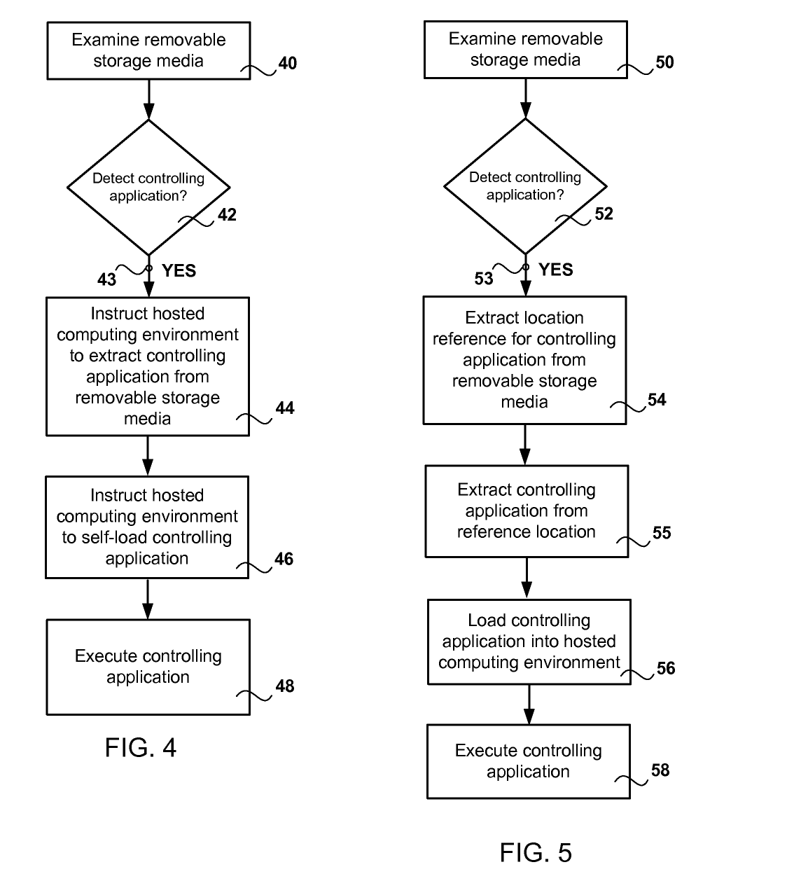

Some embodiments of the present invention may be described in relation to FIG. 4. An imaging device may initiate an examination 40 of a removable storage media. The imaging device may initiate the examination 40 when the removable storage media is communicatively coupled with the imaging device, when manually initiated by a user, when interactively initiated by a user upon prompting by the imaging device or when instructed to do so by a remote computing device. The examination may be initiated 40 to detect 42 whether or not a controlling application resides on the removable storage media. Exemplary methods by which the imaging device may detect 42 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects the presence of a potential controlling application, the imaging device may continue to read additional bytes until the presence or absence of a controlling application may be verified.

If the imaging device detects 43 a controlling application on the removable storage media, then the imaging device may instruct a hosted computing environment to extract 44 the controlling application from the storage media if the controlling application is wholly present on the storage media. Exemplary hosted computing environments may comprise an external or remote server, an external computing device and a guest operating environment within the imaging device. The imaging device may then instruct the hosted computing environment to self-load 46 the controlling application. The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 48. In some embodiments, execution 48 of the controlling application may be initiated manually by a user at the imaging device or elsewhere. In alternative embodiments, execution 48 of the controlling application may be initiated automatically by the hosted computing environment. In some embodiments, a hosted computing environment may run a monitoring process which may, continuously, periodically or on a defined schedule, monitor a predefined location for newly loaded controlling applications.

Some embodiments of the present invention may be described in relation to FIG. 5. An imaging device may initiate an examination 50 of a removable storage media. The imaging device may initiate the examination 50 when the removable storage media is communicatively coupled with the imaging device, when manually initiated by a user, when interactively initiated by a user upon prompting by the imaging device or when instructed to do so by a remote computing device. The examination may be initiated 50 to detect 52 whether or not a controlling application resides on the removable storage media. Exemplary methods by which the imaging device may detect 52 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects a potential presence, the imaging device may continue to read additional bytes until the presence or absence of a controlling application may be verified.

If the imaging device detects 53 a controlling application on the removable storage media, then the imaging device may extract 54 a location reference for the controlling application from the storage media. Exemplary location references may comprise a URL (Uniform Resource Locator), a URI (Uniform Resource Indicator), a soft-link to a network file path, metadata containing a path link and an executable, such as a batch file, that when invoked may retrieve the controlling application. The imaging device may then extract 55 the controlling application from the reference location. The imaging device may then load 56 the controlling application into a hosted computing environment that may control the imaging device. Exemplary hosted computing environments may comprise an external or remote server, an external computing device and a guest operating environment within the imaging device. Exemplary methods by which the imaging device may load 56 the controlling application into a predefined location on the hosted computing environment may comprise FTP, HTTP, NFS, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make an RPC call to the hosted computing environment to initiate a process on the hosted computing environment to initiate the load application process.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 58. In some embodiments, execution 58 of the controlling application may be initiated manually by a user at the imaging device or elsewhere. In alternative embodiments, execution 58 of the controlling application may be initiated automatically by the hosted computing environment. In some embodiments, a hosted computing environment may run a monitoring process which may, continuously, periodically or on a defined schedule, monitor a predefined location for newly loaded controlling applications.

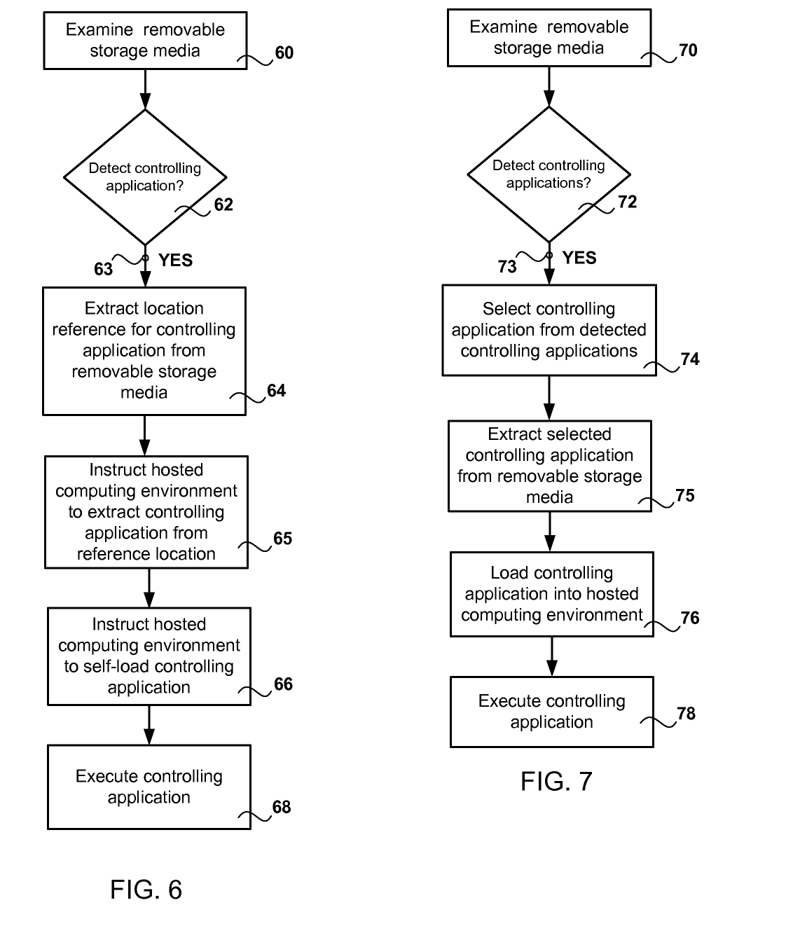

Some embodiments of the present invention may be described in relation to FIG. 6. An imaging device may initiate an examination 60 of a removable storage media. The imaging device may initiate the examination 60 when the removable storage media is communicatively coupled with the imaging device, when manually initiated by a user, when interactively initiated by a user upon prompting by the imaging device or when instructed to do so by a remote computing device. The examination may be initiated 60 to detect 62 whether or not a controlling application resides on the removable storage media. Exemplary methods by which the imaging device may detect 62 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects the presence of a potential controlling application, the imaging device may continue to read additional bytes until the presence or absence of a controlling application may be verified.

If the imaging device detects 63 a controlling application on the removable storage media, then the imaging device may extract 64 a location reference for the controlling application from the storage media. Exemplary location references may comprise a URL, a URI, a soft-link to a network file path, metadata containing a path link and an executable, such as a batch file, that when invoked may retrieve the controlling application. The imaging device may then instruct a hosted computing environment to extract 65 the controlling application from the reference location. Exemplary hosted computing environments may comprise an external or remote server, an external computing device and a guest operating environment within the imaging device. The imaging device may then instruct the hosted computing environment to self-load 66 the controlling application.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 68. In some embodiments, execution 68 of the controlling application may be initiated manually by a user at the imaging device or elsewhere. In alternative embodiments, execution 68 of the controlling application may be initiated automatically by the hosted computing environment. In some embodiments, a hosted computing environment may run a monitoring process which may, continuously, periodically or on a defined schedule, monitor a predefined location for newly loaded controlling applications.

Some embodiments of the present invention may be described in relation to FIG. 7. An imaging device may initiate an examination 70 of a removable storage media. The imaging device may initiate the examination 70 when the removable storage media is communicatively coupled with the imaging device, when manually initiated by a user, when interactively initiated by a user upon prompting by the imaging device or when instructed to do so by a remote computing device. The examination may be initiated 70 to detect 72 whether or not controlling applications reside on the removable storage media. Exemplary methods by which the imaging device may detect 72 the presence of a controlling application 72 comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest.

If the imaging device detects the presence of a potential controlling application, the imaging device may continue to read additional bytes until the presence or absence of a controlling application may be verified. If the imaging device detects 73 a controlling application or multiple controlling applications, then a controlling application may be selected 74 from the detected controlling applications. In some embodiments of the present invention, a dialog may be displayed at the imaging device to allow a user to select 74 a controlling application from the detected controlling applications. In alternative embodiments, the controlling application may be selected 74 automatically. Exemplary criteria for automatically selecting 74 a controlling application comprise selecting a controlling application when it is the only controlling application detected, selecting a controlling application related to a selected imaging operation (e.g., scan, print, fax, file, copy), selecting a controlling application related to input data file format, selecting a controlling application related to an imaging operation parameter (e.g., barcode, output format, compression method) and selecting a controlling application according to user identification, user authority or user role (e.g., administrative assistant, realtor, accountant). In some embodiments, the imaging device may determine if a controlling application relates to the selection criteria by exemplary methods including those based on file name sequence and metadata.

In embodiments requiring user selection of a controlling application, the imaging device may timeout if a selection is not made within a predetermined time period. Exemplary actions upon timeout may comprise return of the imaging device to a default or normal mode, default to a predefined controlling application which may be registered with the imaging device and refusal of access to the imaging device to the user.

After selection 74 of a controlling application, then the imaging device may extract 75 the selected controlling application from the storage media if the controlling application is wholly present on the storage media. In some embodiments, extraction 75 of the selected controlling application may be performed directly by the imaging device. In alternative embodiments, extraction 75 of the selected controlling application may be performed indirectly by the imaging device. In these embodiments, the imaging device may instruct a hosted computing environment to perform the extraction. Exemplary hosted computing environments may comprise an external or remote server, an external computing device and a guest operating environment within the imaging device.

The imaging device may then load 76 the selected controlling application into a hosted computing environment that may control the imaging device. In some embodiments, loading 76 the selected controlling application may be performed directly by the imaging device. Exemplary methods by which the imaging device may load 76 the controlling application into a predefined location on the hosted computing environment may comprise FTP, NFS, HTTP, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make an RPC call to the hosted computing environment to initiate a process on the hosted computing environment which may initiate the load application process. In alternative embodiments, loading 76 the selected controlling application by be performed indirectly by the imaging device. In these embodiments, the imaging device may instruct a hosted computing environment to self-load the selected controlling application.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 78. In some embodiments, execution 78 of the controlling application may be initiated manually by a user at the imaging device or elsewhere. In alternative embodiments, execution 78 of the controlling application may be initiated automatically by the hosted computing environment. In some embodiments, a hosted computing environment may run a monitoring process which may, continuously, periodically or on a defined schedule, monitor a predefined location for newly loaded controlling applications.

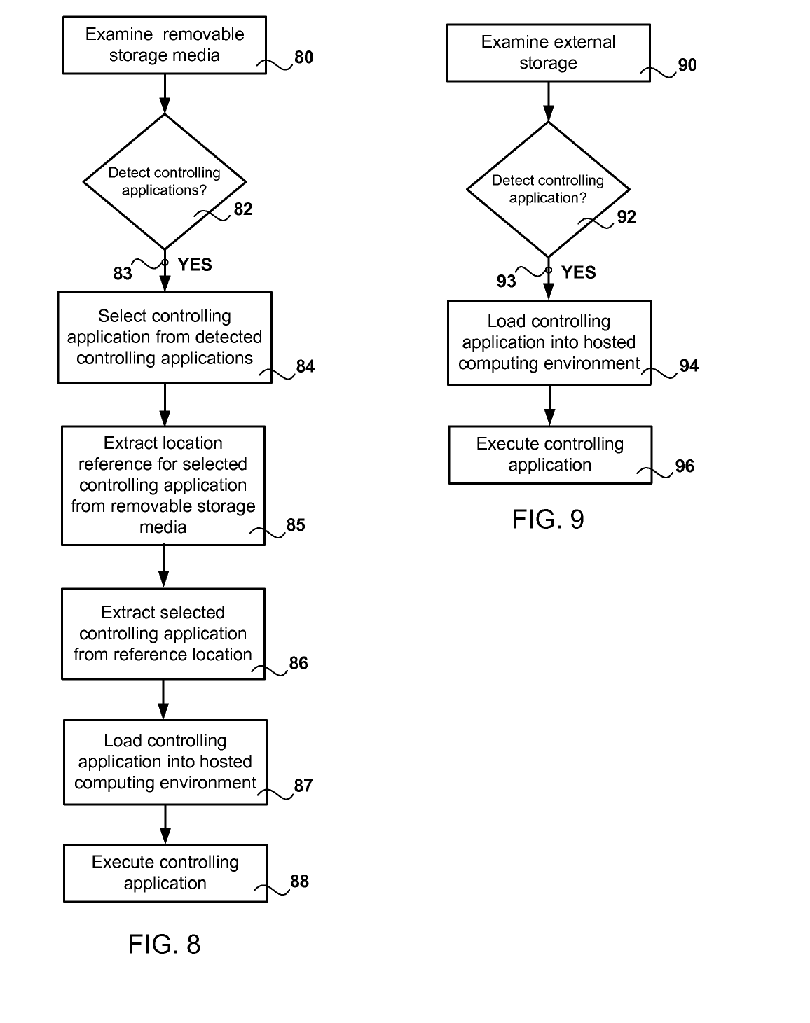

Some embodiments of the present invention may be described in relation to FIG. 8. An imaging device may initiate an examination 80 of a removable storage media. The imaging device may initiate the examination 80 when the removable storage media is communicatively coupled with the imaging device, when manually initiated by a user, when interactively initiated by a user upon prompting by the imaging device or when instructed to do so by a remote computing device. The examination may be initiated 80 to detect 82 whether or not controlling applications reside on the removable storage media. Exemplary methods by which the imaging device may detect 82 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest.

If the imaging device detects the presence of a potential controlling application, the imaging device may continue to read additional bytes until the presence or absence of a controlling application may be verified. If the imaging device detects 83 a controlling application or multiple controlling applications, then a controlling application may be selected 84 from the detected controlling applications. In some embodiments of the present invention, a dialog may be displayed at the imaging device to allow a user to select 84 a controlling application from the detected controlling applications. In alternative embodiments, the controlling application may be selected 84 automatically. Exemplary criteria for automatically selecting 84 a controlling application comprise selecting a controlling application when it is the only controlling application detected, selecting a controlling application related to a selected imaging operation (e.g., scan, print, fax, file, copy), selecting a controlling application related to input data file format, selecting a controlling application related to an imaging operation parameter (e.g., barcode, output format, compression method) and selecting a controlling application according to user identification, user authority or user role (e.g., administrative assistant, realtor, accountant). In some embodiments, the imaging device may determine if a controlling application relates to the selection criteria by exemplary methods including those based on file name sequence and metadata. In embodiments requiring user selection of a controlling application, the imaging device may timeout if a selection is not made within a predetermined time period. Exemplary actions upon timeout may comprise return of the imaging device to a default or normal mode, default to a predefined controlling application which may be registered with the imaging device and refusal of access to the imaging device to the user.

After selection 84 of a controlling application, then the imaging device may extract 85 a location reference for the selected controlling application from the storage media. Exemplary location references may comprise a URL, a URI, a soft-link to a network file path, metadata containing a path link and an executable, such as a batch file, that when invoked may retrieve the controlling application. The imaging device may then extract 86 the selected controlling application from the reference location. In some embodiments, extraction 86 of the selected controlling application may be performed directly by the imaging device. In alternative embodiments, extraction 86 of the selected controlling application may be performed indirectly by the imaging device. In these embodiments, the imaging device may instruct a hosted computing environment to perform the extraction. Exemplary hosted computing environments may comprise an external or remote server, an external computing device and a guest operating environment within the imaging device.

The imaging device may then load 87 the selected controlling application into a hosted computing environment that may control the imaging device. In some embodiments, loading 87 the selected controlling application may be performed directly by the imaging device. Exemplary methods by which the imaging device may load 87 the controlling application into a predefined location on the hosted computing environment may comprise FTP, NFS, HTTP, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make an RPC call to the hosted computing environment to initiate a process on the hosted computing environment to initiate the load application process. In alternative embodiments, loading 87 the selected controlling application by be performed indirectly by the imaging device. In these embodiments, the imaging device may instruct a hosted computing environment to self-load the selected controlling application.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 88. In some embodiments, execution 88 of the controlling application may be initiated manually by a user at the imaging device or elsewhere. In alternative embodiments, execution 88 of the controlling application may be initiated automatically by the hosted computing environment. In some embodiments, a hosted computing environment may run a monitoring process which may, continuously, periodically or on a defined schedule, monitor a predefined location for newly loaded controlling applications.

Some embodiments of the present invention may be described in relation to FIG. 9. An imaging device may initiate an examination 90 of an external storage device or location. Exemplary external storage devices and locations may comprise a PDA, a cellular telephone, an FTP site, an HTTP site and an NFS (or otherwise remote) file system. The imaging device may initiate the examination 90 when the external storage device is communicatively coupled with the imaging device, when manually initiated by a user, when interactively initiated by a user upon prompting by the imaging device, when the external storage device is detected in proximity to the imaging device or when instructed to do so by a remote computing device. The examination may be initiated 90 to detect 92 whether or not a controlling application resides on the external storage device or at the external storage location. Exemplary methods by which the imaging device may detect 92 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects the presence of a potential controlling application, the imaging device may continue to read additional bytes until the presence or absence of a controlling application may be verified.

If the imaging device detects 93 a controlling application on the external storage device or at the external storage location, then the imaging device may load 94 the controlling application into a hosted computing environment that may control the imaging device. Exemplary hosted computing environments may comprise an external or remote server, an external computing device, a computing environment within the external storage device and a guest operating environment within the imaging device. Exemplary methods by which the imaging device may load 94 the controlling application into a predefined location on the hosted computing environment may comprise FTP, NFS, HTTP, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make an RPC call to the hosted computing environment to initiate a process on the hosted computing environment that may initiate the load application process.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 96. In some embodiments, execution 96 of the controlling application may be initiated manually by a user at the imaging device or elsewhere. In alternative embodiments, execution 96 of the controlling application may be initiated automatically by the hosted computing environment. In some embodiments, a hosted computing environment may run a monitoring process which may, continuously, periodically or on a defined schedule, monitor a predefined location for newly loaded controlling applications.

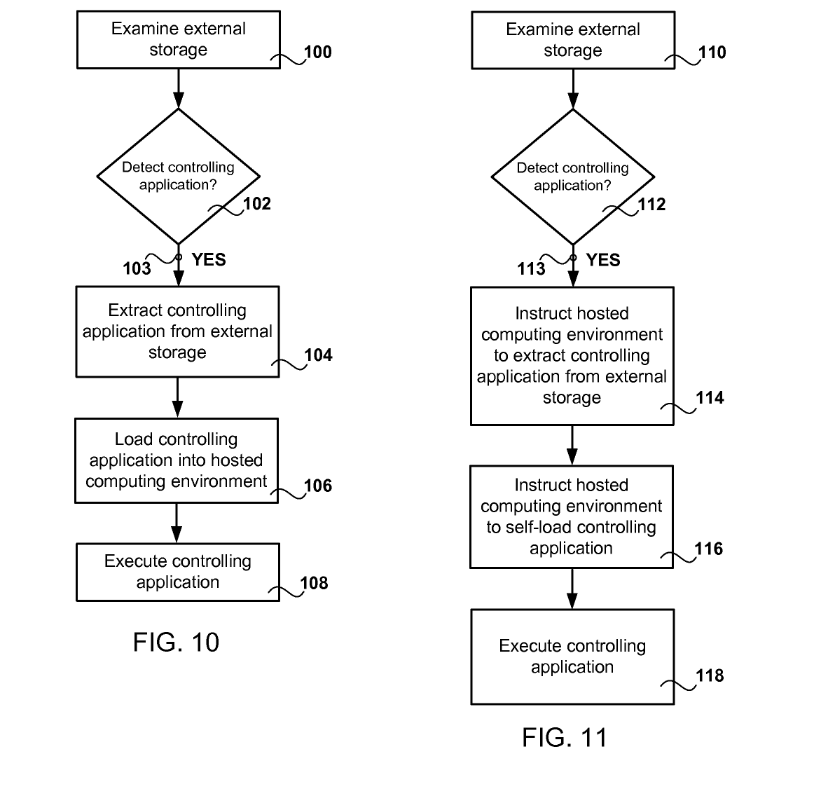

Some embodiments of the present invention may be described in relation to FIG. 10. An imaging device may initiate an examination 100 of an external storage device or an external storage location. Exemplary external storage devices and locations may comprise a PDA, a cellular telephone, an FTP site, an HTTP site and an NFS (or otherwise remote) file system. The imaging device may initiate the examination 100 when the external storage device is communicatively coupled with the imaging device, when manually initiated by a user, when interactively initiated by a user upon prompting by the imaging device, when the external storage device is detected in proximity to the imaging device or when instructed to do so by a remote computing device. The examination may be initiated 100 to detect 102 whether or not a controlling application resides on the external storage device. Exemplary methods by which the imaging device may detect 102 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects a potential presence, the imaging device may continue to read additional bytes until the presence or absence of a controlling application is verified.

If the imaging device detects 103 a controlling application on the external storage device or at the external storage location, then the imaging device may extract 104 the controlling application from the storage device or location if the controlling application is wholly present on the storage device or location. The imaging device may then load 106 the controlling application into a hosted computing environment that may control the imaging device. Exemplary hosted computing environments may comprise an external or remote server, an external computing device, a computing environment within the external storage device and a guest operating environment within the imaging device. Exemplary methods by which the imaging device may load 106 the controlling application into a predefined location on the hosted computing environment may comprise FTP, NFS, HTTP, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make an RPC call to the hosted computing environment to initiate a process on the hosted computing environment which may initiate the load application process.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 108. In some embodiments, execution 108 of the controlling application may be initiated manually by a user at the imaging device or elsewhere. In alternative embodiments, execution 108 of the controlling application may be initiated automatically by the hosted computing environment. In some embodiments, a hosted computing environment may run a monitoring process which may, continuously, periodically or on a defined schedule, monitor a predefined location for newly loaded controlling applications.

Some embodiments of the present invention may be described in relation to FIG. 11. An imaging device may initiate an examination 110 of an external storage device or location. Exemplary external storage devices and locations may comprise a PDA, a cellular telephone, an FTP site, an HTTP site and an NFS (or otherwise remote) file system. The imaging device may initiate the examination 110 when the external storage device is communicatively coupled with the imaging device, when manually initiated by a user, when interactively initiated by a user upon prompting by the imaging device, when the external storage device is detected in proximity to the imaging device or when instructed to do so by a remote computing device. The examination may be initiated 110 to detect 112 whether or not a controlling application resides on the external storage device. Exemplary methods by which the imaging device may detect 112 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects a potential presence, the imaging device may continue to read additional bytes until the presence or absence of a controlling application may be verified.

If the imaging device detects 113 a controlling application on the external storage device, then the imaging device may instruct a hosted computing environment to extract 114 the controlling application from the storage device if the controlling application is wholly present on the storage device or location. Exemplary hosted computing environments may comprise an external or remote server, an external computing device, a computing environment within the external storage device and a guest operating environment within the imaging device. The imaging device may then instruct the hosted computing environment to self-load 116 the controlling application. The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 118. In some embodiments, execution 118 of the controlling application may be initiated manually by a user at the imaging device or elsewhere. In alternative embodiments, execution 118 of the controlling application may be initiated automatically by the hosted computing environment. In some embodiments, a hosted computing environment may run a monitoring process which may, continuously, periodically or on a defined schedule, monitor a predefined location for newly loaded controlling applications.

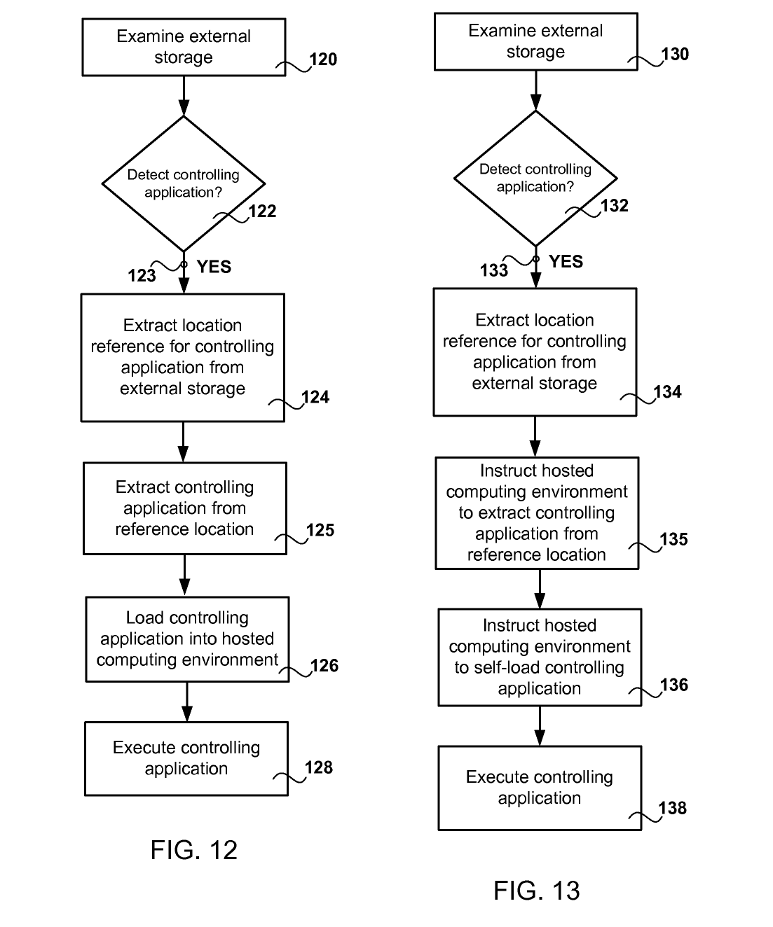

Some embodiments of the present invention may be described in relation to FIG. 12. An imaging device may initiate an examination 120 of an external storage device or location. Exemplary external storage devices and locations may comprise a PDA, a cellular telephone, an FTP site, an HTTP site and an NFS (or otherwise remote) file system. The imaging device may initiate the examination 120 when the external storage device is communicatively coupled with the imaging device, when manually initiated by a user, when interactively initiated by a user upon prompting by the imaging device, when the external storage device is detected in proximity to the imaging device or when instructed to do so by a remote computing device. The examination may be initiated 120 to detect 122 whether or not a controlling application resides on the external storage device or at the external storage location. Exemplary methods by which the imaging device may detect the presence of a controlling application 122 comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects a potential presence, the imaging device may continue to read additional bytes until the presence or absence of a controlling application may be verified.

If the imaging device detects 123 a controlling application on the external storage device, then the imaging device may extract 124 a location reference for the controlling application from the storage device. Exemplary location references may comprise a URL, a URI, a soft-link to a network file path, metadata containing a path link and an executable, such as a batch file, that when invoked may retrieve the controlling application. The imaging device may then extract 125 the controlling application from the reference location. The imaging device may then load 126 the controlling application into a hosted computing environment that may control the imaging device. Exemplary hosted computing environments may comprise an external or remote server, an external computing device, a computing environment within the external storage device and a guest operating environment within the imaging device. Exemplary methods by which the imaging device may load 126 the controlling application into a predefined location on the hosted computing environment may comprise FTP, NFS, HTTP, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make an RPC call to the hosted computing environment to initiate a process on the hosted computing environment which may initiate the load application process.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 128. In some embodiments, execution 128 of the controlling application may be initiated manually by a user at the imaging device or elsewhere. In alternative embodiments, execution 128 of the controlling application may be initiated automatically by the hosted computing environment. In some embodiments, a hosted computing environment may run a monitoring process which may, continuously, periodically or on a defined schedule, monitor a predefined location for newly loaded controlling applications.

Some embodiments of the present invention may be described in relation to FIG. 13. An imaging device may initiate an examination 130 of an external storage device or location. Exemplary external storage devices and locations may comprise a PDA, a cellular telephone, an FTP site, an HTTP site and an NFS (or otherwise remote) file system. The imaging device may initiate the examination 130 when an external storage device or location is communicatively coupled with the imaging device, when manually initiated by a user, when interactively initiated by a user upon prompting by the imaging device, when the external storage device is detected in proximity to the imaging device or when instructed to do so by a remote computing device. The examination may be initiated 130 to detect 132 whether or not a controlling application resides on the external storage. Exemplary methods by which the imaging device may detect 132 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects the presence of a potential controlling application, the imaging device may continue to read additional bytes until the presence or absence of a controlling application may be verified.

If the imaging device detects 133 a controlling application on the external storage, then the imaging device may extract 134 a location reference for the controlling application from the external storage. Exemplary location references may comprise a URL, a URI, a soft-link to a network file path, metadata containing a path link and an executable, for example a batch file, that when invoked may retrieve the controlling application. The imaging device may then instruct a hosted computing environment to extract 135 the controlling application from the reference location. Exemplary hosted computing environments may comprise an external or remote server, an external computing device, a computing environment within the external storage device or location and a guest operating environment within the imaging device. The imaging device may then instruct the hosted computing environment to self-load 66 the controlling application.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 138. In some embodiments, execution 138 of the controlling application may be initiated manually by a user at the imaging device or elsewhere. In alternative embodiments, execution 138 of the controlling application may be initiated automatically by the hosted computing environment. In some embodiments, a hosted computing environment may run a monitoring process which may, continuously, periodically or on a defined schedule, monitor a predefined location for newly loaded controlling applications.

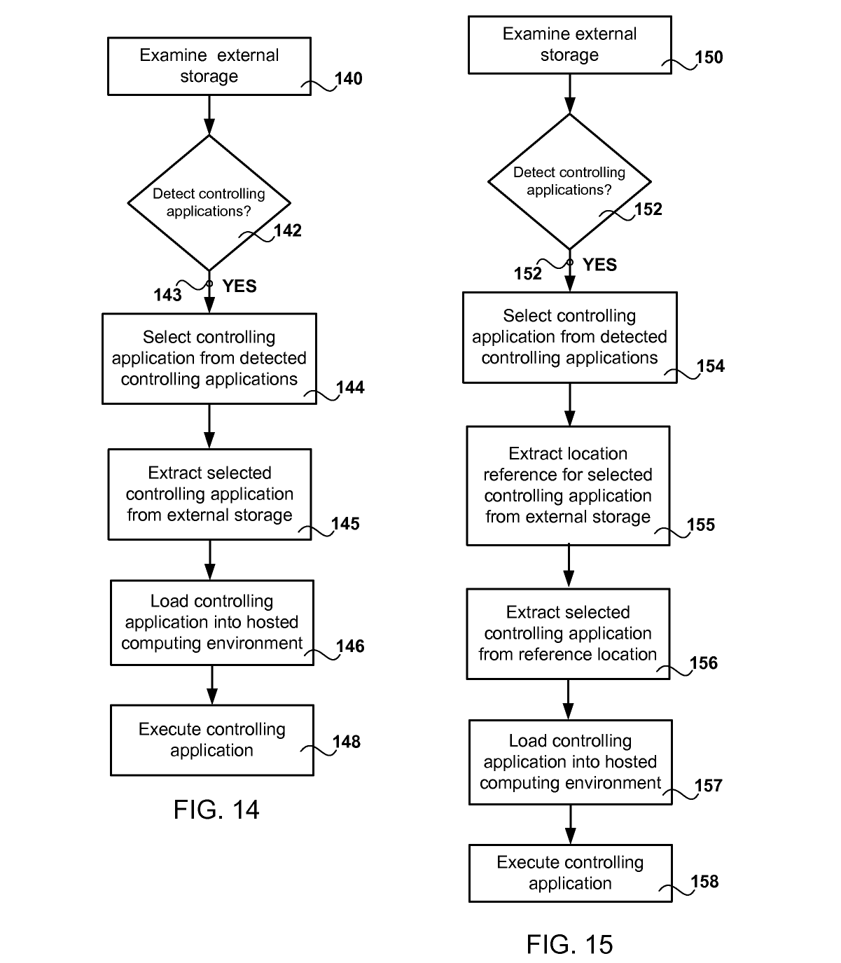

Some embodiments of the present invention may be described in relation to FIG. 14. An imaging device may initiate an examination 140 of an external storage device or location. The imaging device may initiate the examination 140 when the external storage device or location is communicatively coupled with the imaging device, when manually initiated by a user, when interactively initiated by a user upon prompting by the imaging device, when the external storage device is detected in proximity to the imaging device or when instructed to do so by a remote computing device. The examination may be initiated 140 to detect 142 whether or not controlling applications reside on the external storage device or at the external storage location. Exemplary methods by which the imaging device may detect 142 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest.

If the imaging device detects the presence of a potential controlling application, the imaging device may continue to read additional bytes until the presence or absence of a controlling application is verified. If the imaging device detects 143 a controlling application or multiple controlling applications, then a controlling application may be selected 144 from the detected controlling applications. In some embodiments of the present invention, a dialog may be displayed at the imaging device to allow a user to select 144 a controlling application from the detected controlling applications. In alternative embodiments, the controlling application may be selected 144 automatically. Exemplary criteria for automatically selecting 144 a controlling application comprise selecting a controlling application when it is the only controlling application detected, selecting a controlling application related to a selected imaging operation (e.g., scan, print, fax, file, copy), selecting a controlling application related to input data file format, selecting a controlling application related to an imaging operation parameter (e.g., barcode, output format, compression method) and selecting a controlling application according to user identification, user authority, or user role (e.g., administrative assistant, realtor, accountant). In some embodiments, the imaging device may determine if a controlling application relates to the selection criteria by exemplary methods including those based on file name sequence and metadata. In embodiments requiring user selection of a controlling application, the imaging device may timeout if a selection is not made within a predetermined time period. Exemplary actions upon timeout may comprise return of the imaging device to a default or normal mode, default to a predefined controlling application which may be registered with the imaging device and refusal of access to the imaging device to the user.

After selection 144 of a controlling application, then the imaging device may extract 145 the selected controlling application from the external storage on the external storage device or at the external storage location if the controlling application is wholly present. In some embodiments, extraction 145 of the selected controlling application may be performed directly by the imaging device. In alternative embodiments, extraction 145 of the selected controlling application may be performed indirectly by the imaging device. In these embodiments, the imaging device may instruct a hosted computing environment to perform the extraction. Exemplary hosted computing environments may comprise an external or remote server, an external computing device, a computing environment within the external storage device, and a guest operating environment within the imaging device.

The imaging device may then load 146 the selected controlling application into a hosted computing environment that may control the imaging device. In some embodiments, loading 146 the selected controlling application may be performed directly by the imaging device. Exemplary methods by which the imaging device may load 146 the controlling application into a predefined location on the hosted computing environment may comprise FTP, NFS, HTTP, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make an RPC call to the hosted computing environment to initiate a process on the hosted computing environment to initiate the load application process. In alternative embodiments, loading 146 the selected controlling application by be performed indirectly by the imaging device. In these embodiments, the imaging device may instruct a hosted computing environment to self-load the selected controlling application.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 148. In some embodiments, execution 148 of the controlling application may be initiated manually by a user at the imaging device or elsewhere. In alternative embodiments, execution 148 of the controlling application may be initiated automatically by the hosted computing environment. In some embodiments, a hosted computing environment may run a monitoring process which may, continuously, periodically or on a defined schedule, monitor a predefined location for newly loaded controlling applications.

Some embodiments of the present invention may be described in relation to FIG. 15. An imaging device may initiate an examination 150 of an external storage device or external storage location. Exemplary external storage devices and locations may comprise a PDA, a cellular telephone, an FTP site, an HTTP site and an NFS (or otherwise remote) file system. The imaging device may initiate the examination 150 when the external storage device or external storage location is communicatively coupled with the imaging device, when manually initiated by a user, when interactively initiated by a user upon prompting by the imaging device, when the external storage device is detected in proximity to the imaging device or when instructed to do so by a remote computing device. The examination may be initiated 150 to detect 152 whether or not controlling applications reside on the external storage device or at the external storage location. Exemplary methods by which the imaging device may detect 152 the presence of a controlling application comprise detection based on file name, on file name sequence via a regular express match, on file suffix and on metadata stored within or with a file (for example, a file encapsulated with a metadata header or a metadata file with a predefined name). In some embodiments, the imaging device may read a subset of data (e.g., an initial or ending byte sequence) of each file to detect the presence of metadata or a metadata sequence of interest. If the imaging device detects a potential presence, the imaging device may continue to read additional bytes until the presence or absence of a controlling application is verified. If the imaging device detects 153 a controlling application or multiple controlling applications, then a controlling application may be selected 154 from the detected controlling applications. In some embodiments of the present invention, a dialog may be displayed at the imaging device to allow a user to select 154 a controlling application from the detected controlling applications. In alternative embodiments, the controlling application may be selected 154 automatically. Exemplary criteria for automatically selecting 154 a controlling application comprise selecting a controlling application when it is the only controlling application detected, selecting a controlling application related to a selected imaging operation (e.g., scan, print, fax, file, copy), selecting a controlling application related to input data file format, selecting a controlling application related to an imaging operation parameter (e.g., barcode, output format, compression method) and selecting a controlling application according to user identification, user authority, or user role (e.g., administrative assistant, realtor, accountant). In some embodiments, the imaging device may determine if a controlling application relates to the selection criteria by exemplary methods including those based on file name sequence and metadata. In embodiments requiring user selection of a controlling application, the imaging device may timeout if a selection is not made within a predetermined time period. Exemplary actions upon timeout may comprise return of the imaging device to a default or normal mode, default to a predefined controlling application which may be registered with the imaging device and refusal of access to the imaging device to the user.

After selection 154 of a controlling application, then the imaging device may extract 155 a location reference for the selected controlling application from the storage media. Exemplary location references may comprise a URL, a URI, a soft-link to a network file path, metadata containing a path link and an executable, for example a batch file, that when invoked may retrieve the controlling application. The imaging device may then extract 156 the selected controlling application from the reference location. In some embodiments, extraction 156 of the selected controlling application may be performed directly by the imaging device. In alternative embodiments, extraction 156 of the selected controlling application may be performed indirectly by the imaging device. In these embodiments, the imaging device may instruct a hosted computing environment to perform the extraction. Exemplary hosted computing environments may comprise an external or remote server, an external computing device, a computing environment within the external storage device and a guest operating environment within the imaging device.

The imaging device may then load 157 the selected controlling application into a hosted computing environment that may control the imaging device. In some embodiments, loading 157 the selected controlling application may be performed directly by the imaging device. Exemplary methods by which the imaging device may load 157 the controlling application into a predefined location on the hosted computing environment may comprise FTP, NFS, HTTP, AppleTalk®, WS/SOAP and other methods known in the art. In some embodiments, the hosted computing environment may initiate a load application process based on a port or instruction within a network message packet (e.g., WS/SOAP) from the imaging device. In other embodiments, the imaging device may make an RPC call to the hosted computing environment to initiate a process on the hosted computing environment to initiate the load application process. In alternative embodiments, loading 157 the selected controlling application by be performed indirectly by the imaging device. In these embodiments, the imaging device may instruct a hosted computing environment to self-load the selected controlling application.

The hosted computing environment may register the controlling application with the imaging device. Exemplary methods by which the communication address of the imaging device may be determined by the hosted computing environment comprise communication of the address in a network message and communication of the address in metadata that accompanies the controlling application.

The controlling application may then be executed 158. In some embodiments, execution 158 of the controlling application may be initiated manually by a user at the imaging device or elsewhere. In alternative embodiments, execution 158 of the controlling application may be initiated automatically by the hosted computing environment. In some embodiments, a hosted computing environment may run a monitoring process which may, continuously, periodically or on a defined schedule, monitor a predefined location for newly loaded controlling applications.

In some embodiments of the present invention, when an imaging device ceases to be under control of a controlling application, the controlling application may continue to reside on the hosted computing environment and be registered with the imaging device. In alternative embodiments, the controlling application may be unloaded from the hosted computing environment and unregistered with the imaging device.

In some embodiments of the present invention, control of the imaging device by the controlling application may be terminated manually by a user. In alternative embodiments, control of the imaging device by the controlling application may be terminated automatically by the hosted computing environment upon completion of an imaging operation. In still alternative embodiments of the present invention, control of the imaging device by the controlling application may be terminated automatically by the hosted computing environment upon logout of a user. In yet alternative embodiments, the control of the imaging device by the controlling application may be terminated by the imaging device upon removal of the removable media or loss of access to the external storage.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for controlling an imaging device, said method comprising:
a) initiating, from an imaging device, an examination of a storage system, wherein said storage system is communicatively coupled with said imaging device;
b) detecting, from said imaging device, a controlling application residing on said storage system, wherein said controlling application controls at least one function of said imaging device;
c) extracting said controlling application from said storage system;
d) loading said controlling application on a hosted computing environment, wherein said hosted computing environment is communicatively coupled with said imaging device; and
e) controlling said at least one function of said imaging device from said hosted computing environment using said controlling application.

2. A method according to claim 1, wherein said storage system is external to said imaging device.

3. A method according to claim 1, wherein said storage system comprises removable storage media.

4. A method according to claim 1 wherein said extracting further comprises:
a) a first communication to said hosted computing environment from said imaging device, wherein said first communication effectuates said hosted computing environment extracting said controlling application; and
b) a second communication to said hosted computing environment from said imaging device, wherein said second communication effectuates said hosted computing environment self-loading said controlling application.

5. A method according to claim 1, wherein said imaging device is a multi-function peripheral.

6. A method according to claim 1, wherein said hosted computing environment is a remote computing device, a remote server, a computing environment on said storage system, or a guest operating environment on said imaging device.

7. A method according to claim 1, wherein said storage system comprises a personal digital assistant, a cellular telephone, an FTP site, an HTTP site, an NFS file system, a memory stick, a USB thumb drive, a CD/DVD, or a floppy drive.

8. A method for controlling an imaging device, said method comprising:
a) initiating, from an imaging device, an examination of a storage system, wherein said storage system is communicatively coupled with said imaging device;
b) detecting, at said storage system, from said imaging device, a location reference for a controlling application, wherein said location reference identifies the location at which said controlling application resides and wherein said controlling application controls at least one function of said imaging device;
c) extracting said location reference from said storage system;
d) retrieving said controlling application using said location reference;
e) loading said controlling application on a hosted computing environment, wherein said hosted computing environment is communicatively coupled with said imaging device; and
f) controlling said at least one function of said imaging device from said hosted computing environment using said controlling application.

9. A method according to claim 8, wherein said storage system is external to said imaging device.

10. A method according to claim 8, wherein said storage system comprises removable storage media.

11. A method according to claim 8, wherein said retrieving further comprises:
a) a first communication to said hosted computing environment from said imaging device, wherein said first communication effectuates said hosted computing environment retrieving said controlling application using said location reference; and
b) a second communication to said hosted computing environment from said imaging device, wherein said second communication effectuates said hosted computing environment self-loading said controlling application.

12. A method according to claim 8, wherein said imaging device is a multi-function peripheral.

13. A method according to claim 8, wherein said hosted computing environment is a remote computing device, a remote server, a computing environment on said storage system, or a guest operating environment on said imaging device.

14. A method according to claim 8, wherein said storage system comprises a personal digital assistant, a cellular telephone, an FTP site, an HTTP site, an NFS file system, a memory stick, a USB thumb drive, a CD/DVD, or a floppy drive.

15. A method for controlling an imaging device, said method comprising:
a) receiving, at a hosted computing environment from an imaging device, an application for controlling at least one function of said imaging device;
b) registering said application with said imaging device;
c) receiving, at said hosted computing environment from said imaging device, an instruction to launch said application;
d) launching said application; and
e) controlling said at least one function of said imaging device from said hosted computing environment using said application.

16. A method according to claim 15, wherein said imaging device is a multi-function peripheral.

17. A method according to claim 15, wherein said hosted computing environment is a remote computing device, a remote server, a computing environment on said storage system, or a guest operating environment on said imaging device.

18. A method according to claim 15, wherein said receiving, at said hosted computing environment from said imaging device, said application for controlling said at least one function of said imaging device comprises receiving an instruction to extract said application from a storage system.

19. A method according to claim 18, wherein said storage system comprises a personal digital assistant, a cellular telephone, an FTP site, an HTTP site, an NFS file system, a memory stick, a USB thumb drive, a CD/DVD, or a floppy drive.

20. A method according to claim 15, wherein said receiving, at said hosted computing environment from said imaging device, said application for controlling said at least one function of said imaging device comprises:
a) receiving a location reference at said hosted computing environment from said imaging device, wherein said location reference identifies the location at which said application resides;
b) receiving an instruction at said hosted computing environment from said imaging device to retrieve said application from said location at which said application resides; and
c) retrieving said application from said location at which said application resides.
